(19) United States
(12) Patent Application Publication
(10) Pub. No.: US 2016/0309277 A1
(43) Pub. Date: Oct. 20, 2016

(54) SPEAKER ALIGNMENT

(71) Applicant: QUALCOMM Technologies International, Ltd., Cambridge (GB)

(72) Inventor: Paul HISCOCK, Cambridge (GB)

(21) Appl. No.: 14/686,292

(22) Filed: Apr. 14, 2015

(51) Int. Cl. H04S 7/00; H04R 5/04

(52) U.S. Cl. CPC H04S 7/302; H04R 5/04

(57) ABSTRACT

A controller for controlling a system of speakers, the system of speakers being configured to play out audio signals. The controller is configured to, for each speaker of the system of speakers, (i) transmit a signal to that speaker comprising identification data for that speaker, and (ii) transmit a signal to that speaker comprising an indication of a playout time for playing out an identification sound signal comprising the identification data of that speaker. The controller is configured to receive data indicative of a played out identification sound signal from each speaker as received at a listening location, compare the played out identification sound signals received from the speakers, and based on that comparison, control the speakers to adjust parameters of audio signals played out from the speakers so as to align those played out audio signals at the listening location.

This invention relates to calibrating speakers in a speaker system so as to align their audio output.

### BACKGROUND

The increasing popularity of home entertainment systems is leading to higher expectations from the domestic market regarding the functionality, quality and adaptability of the associated speaker systems.

Surround sound systems are popular for use in the home to provide a more immersive experience than is provided by outputting sound from a single speaker alone. FIG. 1 illustrates the arrangement of a 5.1 surround sound system 100. This uses six speakers—front left 102, centre 104, front right 106, surround left 108, surround right 110 and a subwoofer 112. Each speaker plays out a different audio signal, so that the listener is presented with different sounds from different directions. The 5.1 surround system is intended to provide an equalised audio experience for a listener 114 located at the centre of the surround sound system. The location of the speakers is constrained to provide this. Specifically, the front left 102 and front right 106 speakers are generally located at an angle α from a line joining the listener 114 to the centre speaker 104. α is between 22o and 30o, with the smaller angle preferred for listening to audio accompanying movies, and the larger angle preferred for listening to music. The surround left 108 and right 110 speakers are generally located at an angle β from the line joining the listener 114 to the centre speaker 104, where β is about 110o. The subwoofer 112 does not have such a constrained position, but is generally located at the front of the sound system. The centre, front and surround speakers are of the same size and placed the same distance away from the centrally-positioned listener 114.

FIG. 2 illustrates the arrangement of a 7.1 surround sound system 200. The concept is similar to that of the 5.1 surround sound system, this time utilising eight speakers. The surround speakers of the 5.1 surround sound system have been replaced with surround speakers and rear speakers. The surround left 208 and surround right 210 speakers are located at an angle a from the line joining the listener 214 to the centre speaker 204, where θ is between 90o and 110o. The rear left 216 and rear right 218 speakers are behind the listener 214 at an angle of φ from the line joining the listener 214 to the centre speaker 204, where φ is between 135o and 150o. As with the 5.1 surround sound system, the centre, front, surround and rear speakers are all of the same size and placed the same distance away from the centrally-positioned listener 214.

The utility of 5.1 and 7.1 surround sound systems is limited because they require the speakers to be located in specific places in a room, and they also require the listener to be positioned in the middle of the speaker system. This is not practical in many home systems, for example where the shape of the room or the location of doors in a room is such that the speakers cannot be placed in the required positions. Similarly, the location of the sofa or chairs in a room may not be central to the speaker system. If the listener is not equidistant from the speakers, then the audio heard by the listener will be distorted, due to the audio from the nearby speakers being heard before those that are further away. Similarly, if the listener is not equidistant from the speakers, then the audio heard by the listener will be distorted, due to the audio from the nearby speakers being heard louder than those that are further away. Thus, the listening experience is degraded compared to the experience achieved when the ideal set-up of the 5.1 or 7.1 surround sound system is used.

Thus, there is a need for a technique of increasing the quality of the audio playout of a surround sound speaker system experienced by a listener when the listener and/or the speakers do not have ideal positioning described above.

### SUMMARY OF THE INVENTION

According to a first aspect, there is provided a controller for controlling a system of speakers configured to play out audio signals, the controller configured to: for each speaker of the system of speakers, (i) transmit a signal to that speaker comprising identification data for that speaker; and (ii) transmit a signal to that speaker comprising an indication of a playout time for playing out an identification sound signal comprising the identification data of that speaker; receive data indicative of a played out identification sound signal from each speaker as received at a listening location; compare the played out identification sound signals received from the speakers; and based on that comparison, control the speakers to play out audio signals having adjusted parameters so as to align those played out audio signals at the listening location.

The identification data for each speaker may be orthogonal to the identification data of the other speakers in the system of speakers. The identification sound signal for each speaker may be an identification chirp sound signal.

Suitably, for each speaker, the frequency range of the identification sound signal lies within the operating audio frequency range of that speaker, so that the identification sound signal for a tweeter speaker has a frequency range which does not overlap the frequency range of the identification sound signal for a woofer speaker.

The controller may further comprise a store, wherein the controller is configured to: store each speaker's identification data; and perform the claimed comparison by: (i) correlating the received data indicative of played out identification sound signals received from the speakers against the stored identification data to form a correlation response; and (ii) determining adjustment to parameters based on the correlation response.

The controller may be configured to cause the amplitude of audio signals played out from the speakers to be adjusted so that the amplitudes of the audio signals are better matched at the listening location. The controller may be configured to cause the playout time of audio signals from the speakers to be adjusted so that the audio signals are better time synchronised at the listening location. The controller may be configured to cause the phase of the audio signals played out from the speakers to be adjusted so that the phases of the audio signals are better matched at the listening location.

The controller may further be configured to: receive data indicative of a played out identification sound signal from each speaker as received at one or more further listening locations; for each of the further listening locations, compare the played out identification sound signals received from the speakers; and control the speakers to play out audio signals having adjusted parameters so as to improve alignment of those played out audio signals at the listening location and the further listening locations.

The controller may be further configured to: receive data indicative of a played out identification sound signal from each speaker as received at one or more speakers of the system of speakers; for each receiving speaker, compare the playout time of each identification sound signal to the time-of-arrival of the played out identification sound signal; and based on that comparison, determine the locations of the speakers of the system of speakers.

The controller may further assign a channel to each speaker based on the determined locations of the speakers.

The signal comprising the identification data for a speaker and the signal comprising an indication of a playout time for that speaker may form part of the same signal.

The controller may be configured to transmit the same indication of the playout time to each speaker of the system of speakers.

The controller may be configured to transmit different indications of the playout time to each speaker of the system of speakers.

The controller may be configured to transmit and receive signals in accordance with the Bluetooth protocol.

According to a second aspect there is provided a speaker configured to play out audio signals, the speaker configured to: receive a signal comprising identification data for the speaker; receive a signal comprising an indication of a playout time for playing out an identification sound signal comprising the identification data of that speaker; play out the identification sound signal at the playout time; subsequently receive a signal causing audio signals to be played out from the speaker with adjusted parameters; and play out audio signals in accordance with the adjusted parameters.

The identification sound signal may be ultrasonic.

The speaker may be further configured to: receive broadcast audio data according to a wireless communications protocol; and play out the broadcast audio data in accordance with the adjusted parameters.

### BRIEF DESCRIPTION OF THE DRAWINGS

The present invention will now be described by way of example with reference to the accompanying drawings. In the drawings:

FIG. 1 illustrates a 5.1 surround sound system;

FIG. 2 illustrates a 7.1 surround sound system;

FIG. 3 illustrates an unsymmetrical speaker system;

FIG. 4 illustrates a method of calibrating the speaker system of FIG. 3;

FIG. 5 illustrates a correlation response at a listening location from identification signals received from speakers of a speaker system;

FIG. 6 illustrates an exemplary controller or mobile device; and

FIG. 7 illustrates an exemplary speaker.

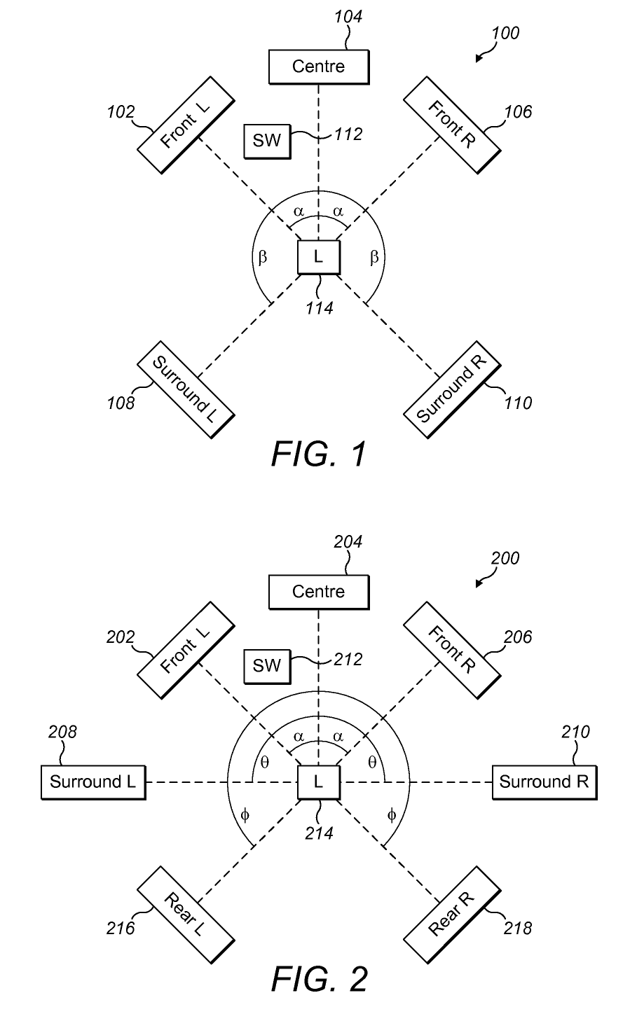

### DETAILED DESCRIPTION

The following description is presented to enable any person skilled in the art to make and use the invention, and is provided in the context of a particular application. Various modifications to the disclosed embodiments will be readily apparent to those skilled in the art. The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The following describes wireless communication devices for transmitting data and receiving that data. That data is described herein as being transmitted in packets and/or frames and/or messages. This terminology is used for convenience and ease of description. Packets, frames and messages have different formats in different communications protocols. Some communications protocols use different terminology. Thus, it will be understood that the terms “packet” and “frame” and “messages” are used herein to denote any signal, data or message transmitted over the network.

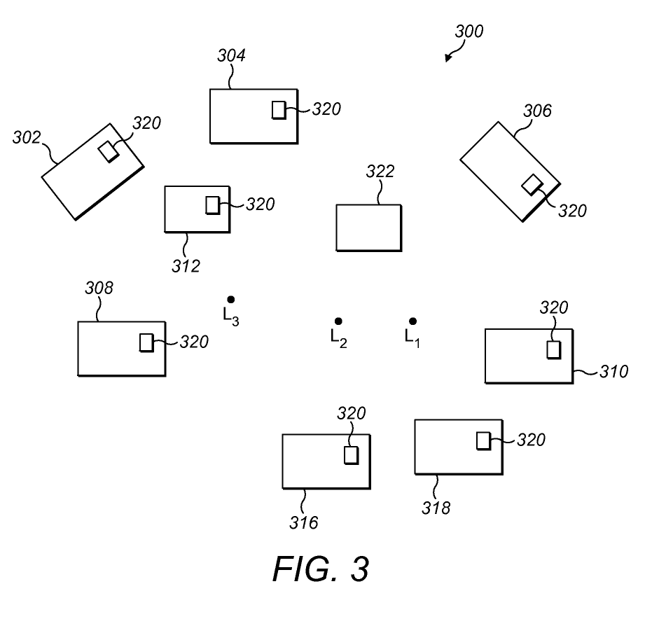

FIG. 3 illustrates an example of a speaker system 300 which is not symmetrical. The speaker system 300 comprises eight speakers 302, 304, 306, 308, 310, 312, 316 and 318. The speakers each comprise a communications unit 320 that enables them to operate according to a communications protocol, for example for receiving audio to play out. Suitably, the communications unit 320 is a wireless communications unit that enables the speaker to operate according to a wireless communications protocol. The speakers each also comprise a speaker unit for playing out audio. Suitably, the speakers are all in line-of-sight of each other. FIG. 3 also illustrates a listening location L1 which is not in the geometric centre of the speaker system. L1 is offset from the geometric centre of the speaker system.

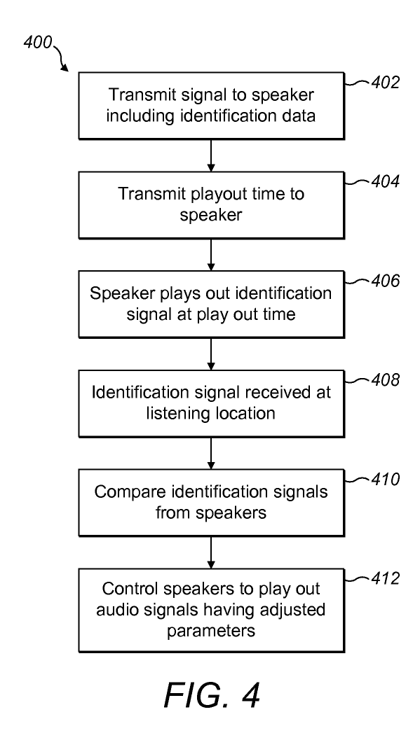

FIG. 4 is a flowchart illustrating a method of calibrating the audio signals played out from the speakers of FIG. 3 in order to align those audio signals at a particular listening location, for example L1. At step 402, a signal is transmitted to each speaker of the speaker system. This signal includes identification data for that speaker. At step 404, a signal is transmitted to each speaker of the speaker system which includes a playout time or data indicative of a playout time for playing out an identification sound signal including the identification data of the speaker. At step 406, each speaker responds to receipt of the signal at step 404 by playing out its identification sound signal at the playout time identified from the signal in step 404. At step 408, the identification sound signal from each speaker is received at listening location L1. At step 410, the identification sounds signals from the speakers of the speaker system as received at listening location L1 are compared. At step 412, the speakers are controlled to play out audio signals having adjusted parameters, the adjusted parameters having been determined based on the comparison of step 410 so as to align the played out audio signals at the listening location L1.

The identification sound signals from the speakers are received at listening location L1 by a microphone. This microphone may, for example, be integrated into a mobile device such as a mobile phone, tablet or laptop. In an exemplary implementation, listening location L1 is selected by the user to be the location where he/she would like the audio to be best aligned in the room. For example, L1 may be chosen to be the location of the user when sat in an armchair from which the user would watch a film. Two microphones may be utilised to receive the identification sounds signals at the positions of the user's ears. For example, this could be implemented by the user holding a mobile device to each ear. Each mobile device would receive the identification sound signals transmitted by the speakers. Alternatively, this could be implemented by the user holding a single mobile device first to one ear, and then once the identification sound signals have been received at that location, moving the mobile device so as to hold it to the other ear, and then causing the identification sounds signals to be transmitted for a second time and received by the mobile device at the location of the other ear. In this way, the subsequent audio played out by the speakers can be adjusted to align it for being listened to by the user's ears at listening location L1. Adjusting parameters in order to align the audio output at two positions (in this case the two ears) is described in more detail later.

The speaker system of FIG. 3 may further include controller 322. Controller 322 may, for example, be located in a sound bar. Controller 322 may be directly connected to the microphone device. The controller 322 may be connected to the microphone device by a wired connection. Alternatively, the controller 322 may be wirelessly connected to the microphone device. Controller 322 may perform steps 402 and 404 of FIG. 4. The controller may transmit the signals of step 402 and/or 404 in response to the user initiating the calibration procedure by interacting with a user interface on the controller, for example by pressing a button on the controller. Alternatively, the controller may transmit the signals of step 402 and/or 404 in response to the user initiating the calibration procedure by interacting with the user interface on a mobile device at the listening location L1. The mobile device then signals the controller 322 to transmit the signals of steps 402 and/or 404. The mobile device may communicate with the controller in accordance with a wireless communications protocol. For example, the mobile device may communicate with the controller using Bluetooth protocols. The controller may transmit the signals of steps 402 and 404 to the speakers over a wireless communications protocol. This may be the same or different to the wireless communications protocol used for communications between the controller and the mobile device.

Alternatively, the mobile device at the listening location L1 may perform steps 402 and 404 of FIG. 4. The mobile device may transmit the signals of steps 402 and/or 404 in response to the user initiating the calibration procedure by interacting with a user interface of the mobile device. The mobile device may communicate with the speakers in accordance with a wireless communications protocol, such as Bluetooth.

The identification data may be transmitted to the speakers prior to the user initiating the current calibration procedure. For example, when a speaker is initially installed into the speaker system, it may be assigned identification data (step 402) which is unique to it within the speaker system. The speaker stores this identification data. For subsequent calibration procedures within that system of speakers, the speaker transmits an identification sound signal comprising the identification data assigned to it at the initial installation. On each subsequent calibration procedure, the speaker receives a playout time (step 404), and plays out the stored identification data in the identification sound signal at the playout time (step 406). Subsequent calibration procedures may be performed, for example, for different listening locations, or because a new speaker has been added to the speaker system, or because the speakers have been moved.

A microphone device at the listening location L1 receives the identification sound signals played out from each speaker in the speaker system. The microphone device may then relay the received identification sound signals onto the controller 322. Alternatively, the microphone device may extract data from the identification sound signals, and forward this data onto the controller 322. This data may include, for example, the identification data of the identification sound signals, absolute or relative time-of-arrivals of the identification sound signals, absolute or relative amplitudes of the identification sound signals, and absolute or relative phases of the identification sound signals. Once the controller 322 has received the relayed or forwarded data, it then compares the identification sound signals received by the microphone from the different speakers of the speaker system (step 410). Based on this comparison, the controller 322 determines how the parameters of the audio signals played out from each speaker are to be adjusted so as to align those parameters of the audio signals as received at the listening location L1, in order to optimise the quality of the sound heard at the listening location L1. The controller then causes the speakers to play out audio signals having those adjusted parameters.

Alternatively, the microphone device at the listening location L1 receives the identification sound signals played out from each speaker in the speaker system. The microphone device then compares the identification sound signals received from the different speakers of the speaker system (step 410) as described above with respect to the controller. Based on this comparison, the microphone device determines how the parameters of the audio signals played out from each speaker are to be adjusted so as to align those parameters of the audio signals as received at the listening location L1, in order to optimise the quality of the sound heard at the listening location L1. The microphone device may then send control signals direct to the speakers to cause them to adjust the parameters of the audio signals they play out accordingly. Alternatively, the microphone device may communicate the parameter adjustments to the controller 322. The controller 322 then causes the speakers to play out audio signals having the adjusted parameters.

Suitably, the identification data of each speaker is unique to that speaker within the speaker system 300. Suitably, the identification data of each speaker is orthogonal to the identification data of the other speakers within the speaker system 300. Suitably, the identification data is capable of being successfully auto-correlated. For example, the identification data may comprise an M-sequence. In this example, each speaker of the speaker system is assigned a different M-sequence. Alternatively, the identification data may comprise a Gold code. In this example, each speaker of the speaker system is assigned a different Gold code. Alternatively, the identification data may comprise one or more chirps, such that the identification sound signal of a speaker is an identification chirp sound signal. In this example, each speaker of the speaker system is assigned a differently coded chirp signal. Chirps are signals which have a frequency which increases or decreases with time. Suitably, the frequency band of the code conveying the identification data is selected in dependence on the operating frequency range of the speaker for which that code is to be the identification data. For example, a tweeter speaker has a different operating frequency range to a woofer speaker. The code for the tweeter speaker is selected to have a frequency band within the frequency range of the tweeter speaker. Similarly, the code for the woofer speaker is selected to have a frequency band within the frequency range of the woofer speaker. The identification sound signal of each speaker may be audible. Alternatively, the identification sound signal of each speaker may be ultrasonic.

The device which performs the comparison step 410 of FIG. 4 initially stores the identification data of each speaker. Suitably, this comparison device also stores the playout times of the identification sound signal of each speaker for that calibration process. This comparison device may perform the comparison by initially correlating the data received from the speakers at the listening location against the stored identification data for the speakers. Since the identification data of one speaker is orthogonal to the identification data of the other speakers in the speaker system, the received data from one speaker correlates strongly with the stored identification data of that speaker and correlates weakly with the stored identification data of the other speakers in the system. The comparison device thereby identifies which identification sound signals are received from which speakers in the speaker system.

In the case that the identification data comprises chirps, the coded chirp in each chirp signal may be selected to be a power-of-2 in length. In other words, the number of samples in the chirp is a power-of-2. This enables a power-of-2 FFT (fast fourier transform) algorithm to be used in the correlation without interpolating the chirp samples. For example, a Cooley-Tukey FFT can be used without interpolation. In contrast, M-sequences and Gold codes are not a power-of-2 in length and so interpolation is used in order to use a power-of-2 FFT algorithm in the correlation.

Once the comparison device has identified received data as originating from a specific speaker, it may compare the time-of-arrival of that received data at the listening location L1 against the stored playout time for that speaker. For each speaker, the comparison device determines a time lag which is the difference between the time-of-arrival of that speaker's identification sound signal at the listening location L1 and the playout time of the identification sound signal from the speaker. The comparison device may then compare the time lags of the speakers in the speaker system in order to determine whether the time lags are equal or not. If the time lags are not equal, then the comparison device determines to modify the time at which the speakers play out audio signals relative to each other so that audio signals from all the speakers are synchronised at the listening location L1. For example, the comparison device may determine the longest time lag of the speakers, and introduce a delay into the timing of the audio playout of all the other speakers so that their audio playout is received at the listening location L1 synchronously with the audio playout from the speaker having the longest time lag. This may be implemented by the speakers being sent control signals to adjust the playout of audio signals so as to add an additional delay. Alternatively, the device which sends the speakers the audio signals to play out may adjust the speaker channels so as to introduce a delay into the timing of all the other speaker channels. In this manner, the device which sends the speakers the audio signals to play out may adjust the timing of the audio on each speaker's channel so as to cause that speaker to play out audio with the adjusted timing. Thus, subsequent audio signals played out by the speakers are received at the listening location L1 aligned in time.

The comparison device may also determine the amplitudes of the signals received from the different speakers of the speaker system. The comparison device may then compare the amplitudes of the speakers in the speaker system in order to determine whether the amplitudes are equal or not. If the amplitudes are not equal, then the comparison device determines to modify the volume levels of the speakers so as to equalise the amplitudes of received audio signals at the listening location L1. The speakers may then be sent control signals to adjust their volume levels as determined. Alternatively, the device which sends the speakers the audio signals to play out may adjust the speaker channels so as to adjust the amplitudes of the audio on the speaker channels in order to better equalise the amplitudes of the received audio signals at the listening location L1. In this manner, the device which sends the speakers the audio signals to play out may adjust the amplitude level of the audio on each speaker's channel so as to cause that speaker to play out audio with the adjusted volume. Thus, subsequent audio signals played out by the speakers are received at the listening location L1 aligned in amplitude.

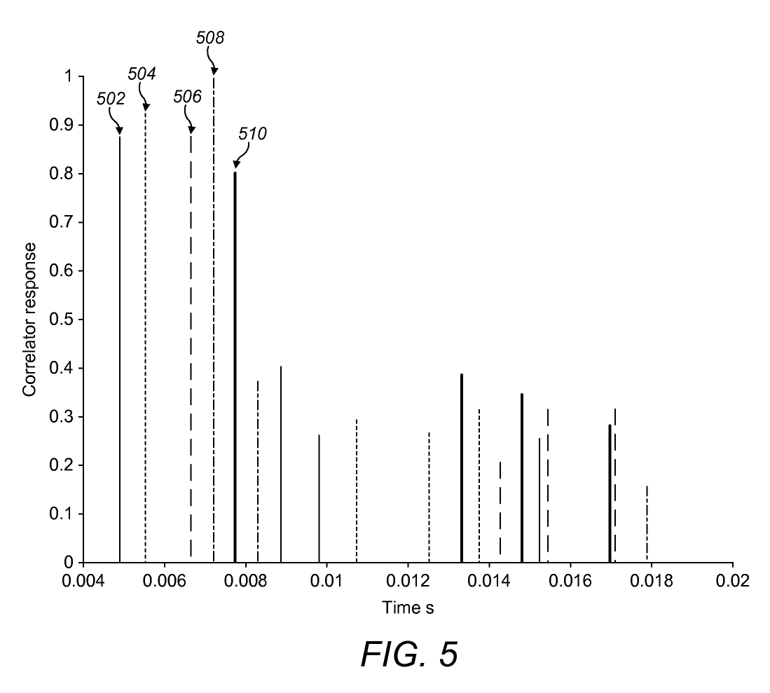

If the speakers in the speaker system simultaneously play out their identification sound signals, then the microphone device at the listening location L1 may compare the correlation responses of the received identification sound signals directly in order to determine relative differences between the correlation responses. In this example, the comparison device does not store playout times of the identification sound signal of each speaker. Instead, the comparison device assumes the identification sound signals were played out simultaneously, and uses relative differences of the parameters of the received identification sound signals from the different speakers at the microphone device to determine relative differences of the speakers. FIG. 5 illustrates the correlation response of identification sound signals received at a listening location from five speakers of a speaker system. Each of the first five correlation peaks 502, 504, 506, 508, 510 represent a different identification sound signal received at the microphone device at the listening location. These first five correlation peaks represent the first time the microphone receives the identification sound signals from those five speakers at that listening location. In other words, those first five correlation peaks are due to receipt of line-of-sight signals. The subsequent peaks in the correlation response are due to subsequent receipt of those same identification sound signals at the microphone due to reflections of the identification sound signals around the room. These subsequent peaks are not used in the methods described herein. The relative delays between the correlation peaks 502, 504, 506, 508 and 510 are determined by the comparison device. Additional delays are then determined to be added to future audio signals played out from the speakers so as to align the correlation peaks so that peaks 502, 504, 506 and 508 all match the timing of peak 510. The relative difference between the amplitudes of the correlation peaks is determined from the height of the correlation peaks by the comparison device. The volume levels of future audio signals played out from the speakers are then determined to be adjusted so as to align the amplitude levels of the correlation peaks. The comparison device may also determine the relative phase of each correlation peak. The phases of future audio signals played out from the speakers are then determined to be adjusted so as to align the phases of the correlation peaks.

The speakers may be configured to play out broadcast audio data. The broadcast audio data is streamed to the speakers from a hub device, which may be controller 322 or another device, via a uni-directional broadcast. For example, the speakers may be configured to play out broadcast audio in accordance with the Connectionless Slave Broadcast of the Bluetooth protocol.

The Connectionless Slave Broadcast (CSB) mode is a feature of Bluetooth which enables a Bluetooth piconet master to broadcast data to any number of connected slave devices. This is different to normal Bluetooth operations, in which a piconet is limited to eight devices: a master and seven slaves. In the CSB mode, the master device reserves a specific logical transport for transmitting broadcast data. That broadcast data is transmitted in accordance with a timing and frequency schedule. The master transmits a synchronisation train comprising this timing and frequency schedule on a Synchronisation Scan Channel. In order to receive the broadcasts, a slave device first implements a synchronisation procedure. In this synchronisation procedure, the slave listens to the Synchronisation Scan Channel in order to receive the synchronisation train from the master. This enables it to determine the Bluetooth clock of the master and the timing and frequency schedule of the broadcast packets. The slave synchronises its Bluetooth clock to that of the master for the purposes of receiving the CSB. The slave device may then stop listening for synchronisation train packets. The slave opens its receive window according to the timing and frequency schedule determined from the synchronisation procedure in order to receive the CSB broadcasts from the master device. The master device, for example controller 322, may broadcast the audio for the different speaker channels. This broadcast is received by the speakers, acting as slaves. The speakers then play out the audio broadcast.

As mentioned above, the speakers of the speaker system may all play out their identification sound signals at the same time. This may happen because the device which transmits the playout times to the speakers at step 404 of FIG. 4 sends the same playout time message to each speaker. For example, this device may encapsulate the playout time in a broadcast packet and broadcast that packet, which is subsequently received by all the speakers. All the speakers respond by playing out their identification sound signals at the playout time indicated in the broadcast packet. Alternatively, the device which transmits the playout times to the speakers at step 404 of FIG. 4 may send a message to each speaker which is individually addressed to that speaker, and the message to each speaker comprises the same playout time. For example, the device may incorporate the playout time in a sub-channel message of a broadcast packet which is addressed to an individual speaker, and broadcast that packet. Only the individually addressed speaker responds to this by playing out its identification sound signal at the playout time.

The device which transmits the identification data and playout times to the speakers at steps 402 and 404 of FIG. 4 may send both the identification data and playout time to a speaker in the same packet. The device may transmit the identification data to each speaker in the system of speakers at the same time with an instruction to play out their identification sound signals immediately. In this way, all of the speakers play out their identification sound signals at the same time. In this particular scenario, the delays between messages being transmitted by the device and received by the speakers are the same or constant and known. If they are constant and known but different, then this is taken into account when comparing the identification sound signals received from the speakers at step 410 of FIG. 4. Each speaker delays the play out of the identification sound signal due to internal processing such as digital processing, filtering, cross-overs, cables, distance to microphone. In this particular scenario, the internal delays of the speakers are the same or constant and known. If they are constant and known but different, then this is taken into account when comparing the identification sound signals received from the speakers at step 410 of FIG. 4.

Each speaker simultaneously playing out its identification sound signal enables the comparison device to compare relative parameters of the signals received at the listening location L1. The microphone device at the listening location L1 is kept still during the time in which the identification sound signals are received from the speakers. By playing out all the identification sound signals simultaneously, the time during which the microphone device is to be kept still is shortened compared to the situation where the identification sound signals are played out one at a time by the speakers. For the implementation in which chirp signals are used for the identification data, the microphone device is held still for ˜100 ms in order to gather samples. The received data samples may then be processed subsequently offline. Real-time processing is not required, thus the processing power required to implement this process is low.

The speakers of the speaker system may play out their identification sound signals at different times. This may happen because the device which transmits the playout times to the speakers at step 404 of FIG. 4 sends different playout times to the speakers. The device may transmit the identification data of a speaker to that speaker with an instruction to play out its identification sound signal immediately. Once that speaker has played out its identification sound, the device may then transmit the identification data of another speaker to that other speaker with an instruction to play out its identification sound signal immediately. In this example, the comparison device does not store the playout times of the identification sound signals of the speakers. The time between transmission of an identification sound signal from one speaker and the transmission of an identification sound signal from the next speaker in the sequence is known to the comparison device. Thus, when analysing the correlation responses, the comparison device deducts the known time-difference-of-transmission of each subsequently received identification sound signal (compared to the first received identification sound signal) from the received time-of-arrival of that identification sound signal in order to then compare the received identification sound signals relatively.

In one example, a single speaker unit may comprise several speakers. For example, a single speaker unit may comprise a tweeter speaker and/or a mid-frequency speaker and/or a woofer speaker. The identification data sent at step 402 of FIG. 4 identifies the speaker unit as a whole. Thus, each of the constituent speakers of the speaker unit plays out an identification sound signal comprising the same identification data. In this case, the constituent speakers of the speaker unit play out their identification sound signals one at a time in a sequence known to the comparison device and at time differences known to the comparison device. The comparison device then compares the relative parameters of the received signals from the constituent speakers as described in the preceding paragraph.

In another example, a single speaker unit may comprise a plurality of base speakers, and/or a plurality of mid-frequency speakers, and/or a plurality of tweeter speakers. The identification data sent at step 402 of FIG. 4 identifies the individual constituent speakers of the speaker unit. Identification data is transmitted at a first time in the base frequency band (10-500 kHz). At this time identification data is transmitted for each of the base speakers of the single speaker unit. The base speakers respond by playing out their identification sound signals. Identification data is transmitted at a second time in the mid-range frequency band (0.5-2 kHz). At this time identification data is transmitted for each of the mid-range frequency band speakers of the single speaker unit. The mid-range frequency band speakers respond by playing out their identification sound signals. Identification data is transmitted at a third time in the treble frequency band (>2 kHz). At this time identification data is transmitted for each of the tweeter speakers of the single speaker unit. The tweeter speakers respond by playing out their identification sound signals. The microphone device receives all the identification sound signals, and the comparison device compares the relative parameters of the constituent speakers as described herein.

In these examples in which a single speaker unit comprises a plurality of constituent speakers in different frequency bands, the adjustments made to signals played out from the single speaker units are frequency band specific. The single speaker unit comprises an equalisation filter. The equalisation filter applies the adjusted parameters to the audio signals played out from the single speaker unit. For example, the equalisation filter may implement one or more of the following: adding a frequency band limited group delay; adding a frequency band adjusted gain; adding a frequency band adjusted phase.

After the speakers have been controlled to play out audio signals having the adjusted parameters at step 412, a check may be performed. This check may be implemented by causing all the speakers to play out their identification data at the same playout time suitably adjusted (as described above), and then comparing the correlation peaks of the different identification sound signals received at the listening location. If the correlation peaks are aligned in time and amplitude to within a determined tolerance, then the check is successful and no further parameter adjustment is made. If the correlation peaks are not aligned in time and amplitude to within the determined tolerance, then the correlation process of FIG. 4 is repeated. The correlation peaks may not be aligned in the check because the microphone device was not kept sufficiently still during the initial calibration process.

The calibration process of FIG. 4 may be repeated for different listening locations. For example, the calibration process may be carried out for a microphone device located at listening location L1 and for a microphone device located at listening location L2 and for a microphone device located at listening location L3. L1 may be one side of a sofa, L2 the other side of a sofa, and L3 an armchair. A set of parameters for each speaker of the speaker system is generated for each listening location, that set of parameters being those which cause the audio signals to be optimally aligned at that listening location. The set of parameters associated with each listening location is stored. For example, the user's mobile device and/or the controller 322 may store the set of parameters for each listening location. Subsequently, the user may select a listening location on the user's mobile device or on the controller. In response to the user selecting the listening location, the speakers are controlled to play out audio signals having the set of parameters associated with that listening location. The speakers may be controlled in this way using any of the methods discussed above.

At step 408 of FIG. 4, the identification sound signal of each speaker is received at a single listening location. Additionally, the identification sound signal of each speaker may be received at one or more further listening locations, for example L2 and L3. The comparison step 410 is then performed in respect of the identification sound signals received at each of the listening locations. The comparison device determines adjusted parameters for audio signals played out from the speakers which improves the alignment of those parameters of the audio signals at each of the listening locations. In this case, the adjusted parameters are not optimal for any one specific listening location, but enhance the listening experience over the listening locations as a whole.

The identification sound signal of each speaker may be received at one or more of the other speakers of the speaker system. Each receiving speaker determines the time-of-arrival of the identification sound signal from each transmitting speaker. The receiving speaker then sends the time-of-arrivals of each identification sound signal to a location-calculating device, which may be the controller 322 or a mobile device. The location-calculating device determines the time lag between each transmitting and receiving device to be the time-of-arrival of the identification sound signal minus the playout time of that identification sound signal. The location-calculating device determines the distance between the transmitting and receiving speakers to be the time lag between those two devices multiplied by the speed of sound in air. Once the location-calculating device has determined the distance between a transmitting speaker and three receiving speakers, it resolves the location of the transmitting speaker. In this manner, the location-calculating device resolves the location of the speakers in the speaker system. In an alternative implementation, the receiving speaker may determine the distance to the transmitting speaker, and then transmit the determined distance to the location-calculating device. In this implementation, the playout time of the transmitting speaker and its identification data is initially transmitted to all of the speakers in the speaker system. The speakers store the playout time and identification data of each speaker.

Each speaker may be assigned a speaker channel based on the determined location of the speakers of the speaker system. The location-calculating device may transmit the determined locations of the speakers in the speaker system to the controller 322 or mobile device. The controller 322 or mobile device then determines which speaker channel to assign to which speaker, and transmits this assignment to the speaker. The speaker then listens to the assigned speaker channel, and plays out the audio from the assigned speaker channel.

The user may manually adjust the parameters of each speaker. For example, the user may interact with the user interface on the mobile device or the controller 322 in order to cause the speakers to play out audio signals having adjusted parameters to achieve a desired effect.

The correlation method described herein enables the parameters of the audio signals played out from the speakers of a speaker system to be adjusted so as to optimally align those audio signals at a listening location without needing to know the location of the speakers or the listener.

The actual location of a speaker within a speaker product and a microphone within a microphone product is not typically known by a user. Thus, even when the locations of the speaker products and microphone product are known, the precision of a calibration process which is based on these locations alone is limited due to these imprecisely known locations. In the methods described herein, the location of the speakers and the listener are not used to determine the adjustments to make to the parameters of the audio signals played out by the speakers. Thus, the methods described herein result in an improved equalisation of the audio signals received at the listening location compared to methods which are based on the location of the speakers and the listener.

The time taken for audio signals to be sent from the sound source to each speaker is either the same, or constant and known. For example, it may be known to be about 20 μs. Synchronised distribution of data to speakers of a speaker system is described in co-pending U.S. Ser. No. 13/299,586 incorporated herein by reference. For example, the time taken for broadcast audio data to be transmitted from the controller 322 and received by each of the speakers in the speaker system is either the same, or constant and known. If this time is constant and known but different for different speakers, then this is taken into account when determining the delay to add onto the audio signals played out by each speaker. In other words, the delay to add to the audio played out from a speaker is determined based on the following times for all the speakers in the speaker system:

time taken for the audio broadcast to reach each speaker from the sound source,

the time taken for each speaker to process that audio broadcast for playout, and

the time taken for the listener to receive that played out audio from each speaker.

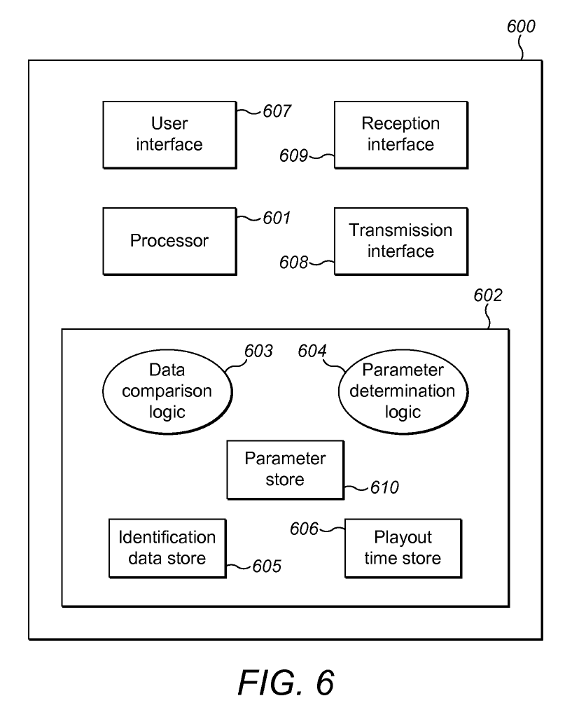

Reference is now made to FIG. 6. FIG. 6 illustrates a computing-based device 600 in which the described controller or mobile device can be implemented. The computing-based device may be an electronic device. The computing-based device illustrates functionality used for transmitting identification data and playout times to a speaker, receiving data indicative of a played out identification sound signal, comparing played out identification sound signals, and controlling speakers to play out adjusted parameters.

Computing-based device 600 comprises a processor 601 for processing computer executable instructions configured to control the operation of the device in order to perform the calibration method. The computer executable instructions can be provided using any non-transient computer-readable media such as memory 602. Further software that can be provided at the computer-based device 600 includes data comparison logic 603 which implements step 410 of FIG. 4, and parameter determination logic 604 which implements steps 410 and 412 of FIG. 4. Alternatively, the controller for performing the data comparison and parameter determination are implemented partially or wholly in hardware. Store 605 stores the identification data of each speaker. Store 606 stores the playout time of the identification data of each speaker. Store 610 stores the parameters of different listening locations. Computing-based device 600 also comprises a user interface 607. The user interface 607 may be, for example, a touch screen, one or more buttons, a microphone for receiving voice commands, a camera for receiving user gestures, a peripheral device such as a mouse, etc. The user interface 607 allows a user to control the initiation of a calibration process, and to manually adjust parameters of the audio signals played out by the speakers. The computing-based device 600 also comprises a transmission interface 608 and a reception interface 609. The transmitter and receiver collectively include an antenna, radio frequency (RF) front end and a baseband processor. In order to transmit signals the processor 601 can drive the RF front end, which in turn causes the antenna to emit suitable RF signals. Signals received at the antenna can be pre-processed (e.g. by analogue filtering and amplification) by the RF front end, which presents corresponding signals to the processor 601 for decoding.

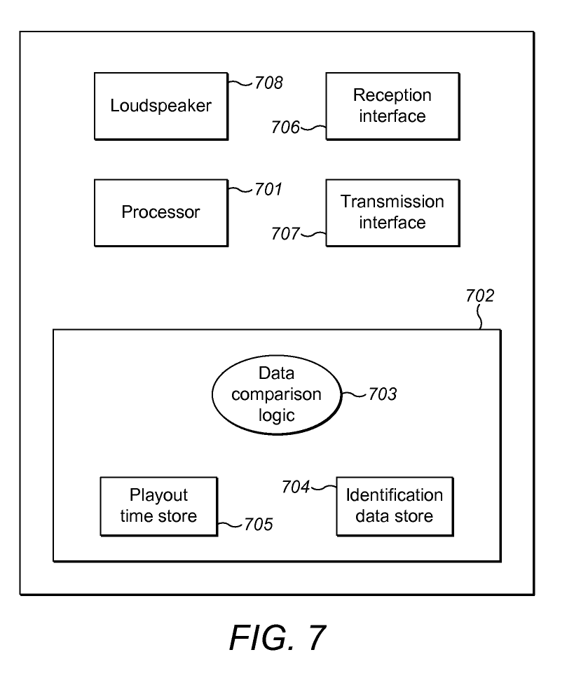

Reference is now made to FIG. 7. FIG. 7 illustrates a computing-based device 700 in which the described speaker can be implemented. The computing-based device may be an electronic device. The computing-based device illustrates functionality used for receiving identification data and playout times, playing out identification sound signals, and playing out audio signals.

Computing-based device 700 comprises a processor 701 for processing computer executable instructions configured to control the operation of the device in order to perform the reception and playing out method. The computer executable instructions can be provided using any non-transient computer-readable media such as memory 702. Further software that can be provided at the computer-based device 700 includes data comparison logic 703. Alternatively, the data comparison may be implemented partially or wholly in hardware. Store 704 stores the identification data of the speaker. Store 705 stores the playout time of the identification data of the speaker. Computing-based device 700 further comprises a reception interface 706 for receiving signals from the controller and/or mobile device and sound source. The computing-based device 700 may additionally include transmission interface 707. The transmitter and receiver collectively include an antenna, radio frequency (RF) front end and a baseband processor. In order to transmit signals the processor 701 can drive the RF front end, which in turn causes the antenna to emit suitable RF signals. Signals received at the antenna can be pre-processed (e.g. by analogue filtering and amplification) by the RF front end, which presents corresponding signals to the processor 701 for decoding. The computing-based device 700 also comprises a loudspeaker 708 for playing the audio out locally at the playout time.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A controller for controlling a system of speakers configured to play out audio signals, the controller configured to:
for each speaker of the system of speakers,
(i) transmit a signal to that speaker comprising identification data for that speaker; and
(ii) transmit a signal to that speaker comprising an indication of a playout time for playing out an identification sound signal comprising the identification data of that speaker;
receive data indicative of a played out identification sound signal from each speaker as received at a listening location;
compare the played out identification sound signals received from the speakers; and
based on that comparison, control the speakers to play out audio signals having adjusted parameters so as to align those played out audio signals at the listening location.

2. A controller as claimed in claim 1, wherein the identification data for each speaker is orthogonal to the identification data of the other speakers in the system of speakers.

3. A controller as claimed in claim 1, wherein the identification sound signal for each speaker is an identification chirp sound signal.

4. A controller as claimed in claim 1, wherein for each speaker, the frequency range of the identification sound signal lies within the operating audio frequency range of that speaker, so that the identification sound signal for a tweeter speaker has a frequency range which does not overlap the frequency range of the identification sound signal for a woofer speaker.

5. A controller as claimed in claim 1, further comprising a store, wherein the controller is configured to:
store each speaker's identification data; and
perform the claimed comparison by:
(i) correlating the received data indicative of played out identification sound signals received from the speakers against the stored identification data to form a correlation response; and
(ii) determining adjustment to parameters based on the correlation response.

6. A controller as claimed in claim 1, wherein the controller is configured to cause the amplitude of audio signals played out from the speakers to be adjusted so that the amplitudes of the audio signals are better matched at the listening location.

7. A controller as claimed in claim 1, wherein the controller is configured to cause the playout time of audio signals from the speakers to be adjusted so that the audio signals are better time synchronised at the listening location.

8. A controller as claimed in claim 1, wherein the controller is configured to cause the phase of the audio signals played out from the speakers to be adjusted so that the phases of the audio signals are better matched at the listening location.

9. A controller as claimed in claim 1, further configured to:
receive data indicative of a played out identification sound signal from each speaker as received at one or more further listening locations;
for each of the further listening locations, compare the played out identification sound signals received from the speakers; and
control the speakers to play out audio signals having adjusted parameters so as to improve alignment of those played out audio signals at the listening location and the further listening locations.

10. A controller as claimed in claim 1, further configured to:
receive data indicative of a played out identification sound signal from each speaker as received at one or more speakers of the system of speakers;
for each receiving speaker, compare the playout time of each identification sound signal to the time-of-arrival of the played out identification sound signal; and
based on that comparison, determine the locations of the speakers of the system of speakers.

11. A controller as claimed in claim 10, further configured to assign a channel to each speaker based on the determined locations of the speakers.

12. A controller as claimed in claim 1, wherein the signal comprising the identification data for a speaker and the signal comprising an indication of a playout time for that speaker form part of the same signal.

13. A controller as claimed in claim 1, configured to transmit the same indication of the playout time to each speaker of the system of speakers.

14. A controller as claimed in claim 1, configured to transmit different indications of the playout time to each speaker of the system of speakers.

15. A controller as claimed in claim 1, configured to transmit and receive signals in accordance with the Bluetooth protocol.

16. A speaker configured to play out audio signals, the speaker configured to:
receive a signal comprising identification data for the speaker;
receive a signal comprising an indication of a playout time for playing out an identification sound signal comprising the identification data of that speaker;
play out the identification sound signal at the playout time;
subsequently receive a signal causing audio signals to be played out from the speaker with adjusted parameters; and
play out audio signals in accordance with the adjusted parameters.

17. A speaker as claimed in claim 16, wherein the identification sound signal is ultrasonic.

18. A speaker as claimed in claim 16, further configured to:
receive broadcast audio data according to a wireless communications protocol; and
play out the broadcast audio data in accordance with the adjusted parameters.

19. A speaker as claimed in claim 16, wherein the identification sound signal is an identification chirp sound signal.

20. A speaker as claimed in claim 16, wherein the signal comprising the identification data for the speaker and the signal comprising the indication of the playout time for the speaker form part of the same signal.
